(19) United States
(12) Patent Application Publication
(10) Pub. No.: US 2013/0237646 A1
(43) Pub. Date: Sep. 12, 2013

(54) THERMOREVERSIBLY CROSS-LINKED GRAFT POLYMERS

(71) Applicants: Sylvia Harders, Buchholz (DE); Ludwik Leibler, Paris (FR); Ilias Iliopoulos, Paris (FR); Julie Prevost, Paris (FR)

(72) Inventors: Sylvia Harders, Buchholz (DE); Ludwik Leibler, Paris (FR); Ilias Iliopoulos, Paris (FR); Julie Prevost, Paris (FR)

(73) Assignees: Centre National De La Recherche Scientifique (CNRS ), Paris (FR); Total Raffinage Marketing, Puteaux (FR)

(21) Appl. No.: 13/884,831

(22) PCT Filed: Nov. 8, 2011
(86) PCT No.: PCT/IB11/54974

§ 371 Date: May 10, 2013

(30) Foreign Application Priority Data
Nov. 12, 2010 (FR) 10 59 335

(51) Int. Cl. C08F 36/06; C08L 95/00; C08F 8/34

(52) U.S. Cl. CPC C08F 36/06; C08F 8/34; C08L 95/00
USPC 524/8; 525/332.9; 525/350; 524/575; 524/68

(57) ABSTRACT

A graft polymer PG includes a polymer backbone P and at least one side graft G linked to the polymer backbone, the graft G having the general formula (1): in which R₁ and R₂ represent, separately from one another, straight or branched, unsaturated or saturated hydrocarbon groups, such that the total number of carbon atoms in groups R₁ and R₂ is between 2 and 110; X represents an amide, amino-acid, urea or urethane function, the graft G being linked to the polymer backbone P via the sulphur atom. The graft polymer PG is a polymer that allows thermoreversible cross-linking and can be used in many fields such as coatings, paints, thermoplastics, adhesives, lubricants, fuels, inks, cements, construction materials, rubbers and bitumens. The graft polymer PG can be used in particular for thermoreversibly cross-linking bitumen/polymer compositions and thus for reducing coating, spreading and/or compaction temperatures during the production of bituminous coated materials.

### CROSS-REFERENCE TO RELATED APPLICATIONS

This application is a National Phase Entry of International Application No. PCT/IB2011/054974, filed on Nov. 8, 2011, which claims priority to French Patent Application Serial No. 1059335, filed on Nov. 12, 2010, both of which are incorporated by reference herein.

### TECHNICAL FIELD

The present invention relates to thermoreversibly cross-linked graft polymers. These polymers find an application in numerous fields, and for this reason the present invention also relates to the use of said graft polymers in coatings, paints, thermoplastics, glues, lubricants, fuels, inks, cements, construction materials, rubbers and bitumens. In particular, the invention relates to bitumen/polymer compositions based on bitumen and said graft polymers. Finally the invention relates to the processes for preparing the graft polymers and bitumen/polymer compositions based on bitumen and said graft polymers.

### BACKGROUND

The graft polymers according to the invention are polymers capable of self-assembly, in order to form a supramolecular network via a system of thermoreversible cross-linking. The graft polymers according to the invention are not linked together via covalent bonds, bonds which once formed cannot be broken and which are therefore irreversible, but are linked together via thermoreversible bonds, i.e. which are present in a certain temperature range and disappear in other temperature ranges. This can be particularly advantageous in the technology of coatings in which there is a need for polymers having a low viscosity under high-spead shearing during their application and which become viscous again after their application. This is particularly true in the field of bitumens. To be capable of use, the bitumen must have certain mechanical properties and in particular elastic or cohesive properties. Since bitumen on its own is generally not sufficiently elastic or cohesive, polymers which can optionally be cross-linked, in particular with sulphur, are added. When these polymers are cross-linked, the cross-linking is irreversible. Once the cross-linking has been carried out, it is not possible to return to the initial state that existed before the cross-linking reaction. The cross-linked bitumen/polymer compositions therefore have good mechanical properties, but a very high viscosity. A need therefore exists for polymers having an association between polymer chains which is thermoreversible.

Some examples of associations between molecules which lead to supramolecular polymers exist in the literature. Patent EP0929597 describes supramolecular polymers based on units having ureido-pyrimidone groups. Patent EP1031589 describes supramolecular polymers obtained by reaction between molecules containing isocyanate functions and molecules containing hydroxy, amine or acid functions. Patent Application EP1136506 describes supramolecular polymers based on units with glutarimide functions. Patent EP1202951 describes supramolecular polymers obtained by reaction between an acid or acid chloride with an aromatic derivative substituted by hydroxyl and acid functions. Patent EP1465930 describes supramolecular polymers based on units having imidazolidinone groups. Patent application EP2069422 describes supramolecular polymers originating from the reaction between imidazolidinone derivatives and fatty acid derivatives.

The Applicant has itself developed the supramolecular polymers described in patent applications EP2178924, EP2178925 and EP2217648. The former are based on graft polymers with thiol functions and the latter are obtained by the reaction between mixtures of polymerized fatty acids and molecules comprising urea, amide, urethane or imidazolidinone units. In application EP0799252 by the Applicant, functionalized elastomers are described. These elastomers are functionalized by dithiol derivatives also comprising acid functions which induce cross-linking via hydrogen bonds. The addition of amines can also induce additional cross-linking of the ionomer type.

In patent applications EP2178924 and EP2178925, the process for the preparation of graft polymers involves a polymer and a thiol derivative comprising a long hydrocarbon chain of at least 18 carbon atoms. Although the grafting process works correctly with a thiol derivative of 18 carbon atoms, with the grafting yield ranging from 60% to 80%, the grafting processes involving longer thiol derivatives such as those comprising a long hydrocarbon chain of 40 carbon atoms or 70 carbon atoms are less satisfactory, as the grafting yields are only 20%. Moreover it is very difficult to separate the graft polymers with grafts of 40 carbon atoms or 70 carbon atoms from unreacted thiol derivatives, which can considerably modify the properties of the graft polymers obtained. It is therefore difficult to obtain graft polymers with very long paraffinic domains and this is what the Applicant has in particular sought to improve.

### SUMMARY

In continuing its research, the Applicant has now developed novel graft polymers that can be obtained more easily, while retaining a graft having a paraffinic domain of very great length. Moreover the novel graft polymers have improved thermoreversibility properties due to the introduction of a novel function within these graft polymers. Thus, the novel graft polymers formed particularly effective gels, in particular in an organic solvent such as toluene and also in bitumen. The grafting yield is greater than those obtained previously, with an equivalent quantity of carbon atoms on the graft. The gel formed by the novel graft polymers is present in a certain temperature range and disappears when the temperature rises. The novel graft polymers according to the invention are therefore capable of inducing thermoreversible cross-linking.

Moreover, the Applicant has also developed novel bitumen/polymer compositions having, at the temperatures of use, the properties of the irreversibly cross-linked bitumen/polymer compositions, in particular as regards elasticity and/or cohesion, and having a reduced viscosity at implementation temperatures. Finally, another subject of the invention consists of providing bitumen/polymer compositions which are stable when stored and resistant to aging.

The novel graft polymers according to the invention are polymers GP comprising a main polymer chain P and at least one side graft G connected to the main polymer chain P, the graft G having general formula (1):

—S—R₁—X—R₂ (1)

with:
R₁ and R₂ which represent independently of one another, linear or branched, unsaturated or saturated hydrocarbon groups, such that the total number of carbon atoms of the R₁ and R₂ groups is comprised between 2 and 110,
X which represents an amide, amido-acid, ester, imide, urea or urethane function, said graft G being connected to the main polymer chain P via the sulphur atom.

The presence of the R₁ and R₂ groups allows thermoreversible cross-linking via crystallizable paraffinic domains. At low temperature the interactions of the crystalline zones of the R₁ and R₂ groups combine the polymer chains P, the graft polymer GP is then cross-linked. When the temperature increases, these crystalline zones melt and the cross-linking, the combination of the polymer chains P, disappears. When the temperature decreases again, the R₁ and R₂ groups recrystallize and the cross-linking reappears. The cross-linking is therefore thermoreversible.

Moreover the presence of the X function in the polymer GP makes it possible to reinforce the thermoreversible cross-linking via interactions of the hydrogen bond type or via polar interactions. At low temperature, these interactions make it possible to reinforce the combination, the cross-linking, of the polymer chains P. When the temperature increases, these interactions disappear, as does the cross-linking, the combination of the polymer chains P. When the temperature decreases again, these interactions reappear, as does the cross-linking. These two types of interactions induce a synergistic effect with respect to the cross-linking of the polymer GP.

Finally, as the thermoreversible cross-linking is promoted by R₁ and R₂ groups comprising a large number of carbon atoms, the novel graft polymers make it possible due to a two-step synthesis process, in which firstly the R₁ group is introduced then the R₂ group, to more easily obtain said graft polymers GP with grafts having very long chain lengths. It is in fact more difficult to synthesize a graft polymer GP comprising a single hydrocarbon group than two hydrocarbon groups, with an equal number of carbon atoms. The Applicant has also found that novel graft polymers with small-sized grafts, i.e. grafts comprising short chains, could be synthesized.

The invention relates to a graft polymer GP comprising a main polymer chain P and at least one side graft G connected to the main polymer chain P, the graft G having general formula (1):

—S—R₁—X—R₂ (1)

with R₁ and R₂ which represent independently of one another, linear or branched, unsaturated or saturated hydrocarbon groups such that the total number of carbon atoms of the R₁ and R₂ groups is comprised between 2 and 110, X which represents an amide, amido-acid, ester, imide, urea or urethane function, said graft G being connected to the main polymer chain P via the sulphur atom.

Preferably, the total number of carbon atoms of the R₁ and R₂ groups is comprised between 4 and 90, preferably between 8 and 70, more preferentially between 12 and 50, even more preferentially between 16 and 40, even more preferentially between 18 and 30, even more preferentially between 20 and 24. Preferably, R₁ represents a linear, saturated hydrocarbon group, of formula CₙH₂ₙ and R₂ represents a linear, saturated hydrocarbon group of formula CₘH₂ₘ₊₁ with n and m being integers such that the sum n+m is comprised between 2 and 110. Preferably, n is comprised between 1 and 60, preferably between 2 and 50, more preferentially between 4 and 40, even more preferentially between 6 and 25, even more preferentially between 8 and 20, even more preferentially between 9 and 15, even more preferentially between 10 and 12 and m is comprised between 1 and 50, preferably between 2 and 40, more preferentially between 4 and 30, even more preferentially between 6 and 25, even more preferentially between 8 and 20, even more preferentially between 9 and 15, even more preferentially between 10 and 12.

Preferably, the main polymer chain P results from the copolymerization of conjugated diene units and monovinyl aromatic hydrocarbon units, in particular from the copolymerization of butadiene units and styrene units. Preferably, the content of 1-2 double bond units originating from the conjugated diene, in particular butadiene, is comprised between 5% and 70% by mass, with respect to the total mass of the conjugated diene units, in particular butadiene, preferably between 10% and 60%, more preferentially between 15% and 50%, even more preferentially between 18% and 40%, even more preferentially between 20% and 30%, even more preferentially between 22% and 25%. Preferably, X represents an amide function and the general formula (1) is as follows:

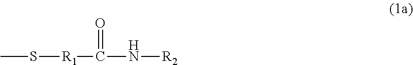

The invention also relates to a process for the preparation of the graft polymer as defined above, in which the following are reacted, in a first step, at least one polymer P and at least one thiol derivative of general formula (2): HS—R₁—Y, then in a second step at least one derivative of general formula (3): Z—R₂, with R₁ and R₂ which represent independently of one another, linear or branched, unsaturated or saturated hydrocarbon groups such that the total number of carbon atoms of the R₁ and R₂ groups is comprised between 2 and 110, Y which represents an acid, alcohol or amine function, Z which represents an acid, alcohol, amine, anhydride or isocyanate function, it being understood that the reaction between the two functions Y and Z leads to the X function of general formula (1). The invention also relates to the use of the graft polymer GP as defined above in coatings, paints, thermoplastics, glues, lubricants, fuels, inks, cements, construction materials, rubbers or bitumens. The invention also relates to a bitumen/polymer composition comprising at least one bitumen and at least one graft polymer GP as defined above. Preferably, the bitumen/polymer composition comprises from 0.1 to 40% by mass of graft polymer GP, with respect to the mass of the bitumen/polymer composition, preferably from 0.5 to 30%, more preferentially from 1 to 20%, even more preferentially from 2 to 10%, even more preferentially from 3 to 5%.

The invention also relates to a process for the preparation of a bitumen/polymer composition in which at least one bitumen and at least one graft polymer GP as defined above, are mixed at a temperature comprised between 80° C. and 200° C., preferably between 100° C. and 180° C., more preferentially between 120° C. and 160° C., for a duration of 30 minutes to 4 hours, preferably 1 hour to 2 hours. The invention also relates to the use of the graft polymer GP as defined above in a bitumen/polymer composition for the thermoreversible cross-linking of said bitumen/polymer composition. The invention also relates to a bituminous mix comprising a bitumen/polymer composition as defined above and granules optionally comprising fines, sand, gravel. The invention also relates to the use of the graft polymer GP as defined above for reducing the coating, spreading and/or compacting temperatures during the production of a bituminous mix.

### DETAILED DESCRIPTION

The invention relates to a graft polymer GP. By graft polymer GP is meant a polymer which comprises a main polymer chain P and side grafts G connected to this chain. The grafts G are connected directly to the main chain P of the polymer, in particular via a sulphur atom. The grafts G are grafted to the main polymer chain P, after polymerization of the latter, by chemical reaction, in one or more steps. The result is a covalent bond between the grafts G and the main chain P of the polymer. The graft polymers GP according to the invention are therefore obtained by polymerization, then grafting of the grafts G and not by polymerization of monomers already comprising grafts G.

The graft polymer GP according to the invention comprises a main polymer chain P and at least one side graft G connected to the main polymer chain P, the graft G having general formula (1):

—S—R₁—X—R₂ (1)

in which:
the R₁ and R₂ groups represent independently of one another, linear or branched, unsaturated or saturated hydrocarbon groups. such that the total number of carbon atoms of the R₁ and R₂ groups is comprised between 2 and 110 and,
the X group is chosen from the amide, amido-acid, ester, imide, urea or urethane functions. It should be noted that the graft G is connected to the main polymer chain P via the sulphur atom.

Preferably, the total number of carbon atoms in the R₁ and R₂ groups is comprised between 4 and 90, more preferentially between 8 and 70, even more preferentially between 12 and 50, even more preferentially between 16 and 40, even more preferentially between 18 and 30, even more preferentially between 20 and 24. The presence of these two R₁ and R₂ groups, via their significant number of carbons is indispensable for the crystallization, the reversible cross-linking of the graft polymer GP. Preferably, the number of carbon atoms of the R₁ group is comprised between 1 and 60, preferably between 2 and 50, more preferentially between 4 and 40, even more preferentially between 6 and 25, even more preferentially between 8 and 20, even more preferentially between 9 and 15, even more preferentially between 10 and 12 and the number of carbon atoms of the R₂ group is comprised between 1 and 50, preferably between 2 and 40, more preferentially between 4 and 30, even more preferentially between 6 and 25, even more preferentially between 8 and 20, even more preferentially between 9 and 15, even more preferentially between 10 and 12.

The R₁ and R₂ groups are preferably linear and saturated hydrocarbon groups, such that the total number of carbon atoms is comprised between 2 and 110, preferably between 4 and 90, more preferentially between 8 and 70, even more preferentially between 12 and 50, even more preferentially between 16 and 40, even more preferentially between 18 and 30, even more preferentially between 20 and 24. The R₁ and R₂ groups are then the CₙH₂ₙ and CₘH₂ₘ₊₁ groups respectively with n and m integers such that the sum n +m is comprised between 2 and 110, preferably between 4 and 90, more preferentially between 8 and 70, even more preferentially between 12 and 50, even more preferentially between 16 and 40, even more preferentially between 18 and 30, even more preferentially between 20 and 24. Preferably, n is comprised between 1 and 60, more preferentially between 2 and 50, even more preferentially between 4 and 40, even more preferentially between 6 and 25, even more preferentially between 8 and 20, even more preferentially between 9 and 15, even more preferentially between 10 and 12 and m is comprised between 1 and 50, more preferentially between 2 and 40, even more preferentially between 4 and 30, even more preferentially between 6 and 25, even more preferentially between 8 and 20, even more preferentially between 9 and 15, even more preferentially between 10 and 12.

The graft polymer GP, in addition to the paraffinic parts defined by the R₁ and R₂ groups, also has a function denoted X. This additional function makes it possible to reinforce the interactions between polymer chains and therefore to reinforce the cross-linking of the graft polymer GP. This X function induces thermoreversible interactions of a polar nature and/or via hydrogen bonds.

The X function is chosen from the amide, amido-acid, ester, imide, urea and urethane functions. The amide, amido-acid, urea and urethane functions induce interactions via hydrogen bonds and polar interactions, while the imide and ester functions only induce polar interactions. According to a particular preferential embodiment, the X function is chosen from the amide, amido-acid, urea and urethane functions so as to induce interactions that are both polar and via hydrogen bonds.

According to the function chosen at the level of the X group, general formula (1) can be written in the following ways, with X an amide function in general formulae (1a) and (1b), X an amido-acid function in general formula (1c), X an ester function in general formulae (1d) and (1e), X an imide function in general formula (1f), X a urea function in general formula (1g) and X a urethane function in general formula (1h):

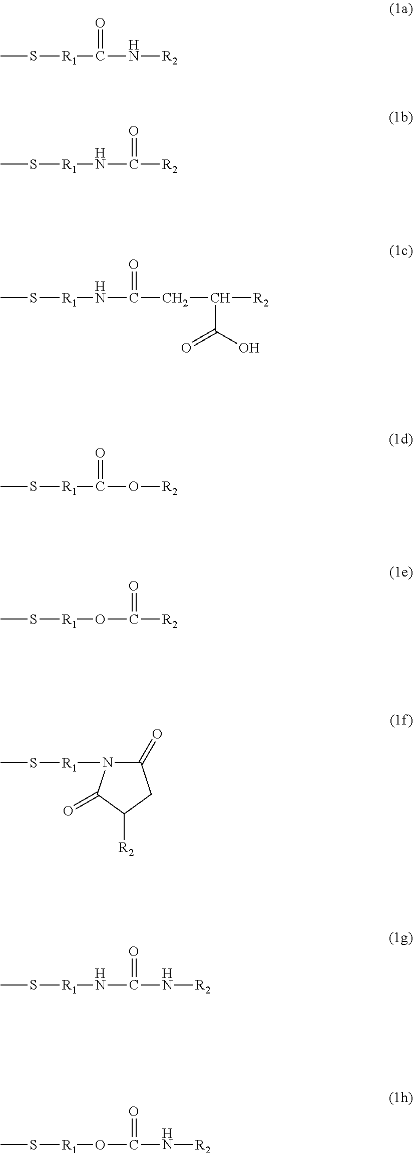

When X is an amide function, it can be in two forms, either the carbonyl is linked to the R₁ group (Formula 1a), or it is linked to the R₂ group (Formula 1b). Similarly, when X is an ester function, either the carbonyl is linked to the R₁ group (Formula 1d), or it is linked to the R₂ group (Formula 1e). Preferably, the X group is an amide function as it can then induce two types of interactions, polar and via hydrogen bond.

The preferred graft polymer GP is such that n is equal to 14 and m is equal 18 and can be represented as: P—S—C₁₄H₂₈—CONH—C₁₈H₃₇ , with P the main polymer chain connected via the sulphur atom with the graft which comprises an amide as X function, C₁₄H₂₈ as the R₁ group and C₁₈H₃₇ as the R₂ group. The graft polymer GP according to the invention comprises a main polymer chain P. This polymer chain P is obtained by polymerization of several monomers. In particular, this polymer chain P is obtained by polymerization of several monomers comprising double bonds. These double bonds are preferably conjugated double bonds.

Preferably, the polymer chain P is obtained by polymerization of conjugated diene units. The conjugated dienes which can be used according to the invention are chosen from those comprising 4 to 8 carbon atoms, such as 1-3 butadiene (butadiene), 2-methyl-1,3-butadiene (isoprene), 2,3-dimethyl-1,3-butadiene, 1,3-pentadiene, 1,2-hexadiene, chloroprene, carboxylated butadiene and/or carboxylated isoprene. Preferably, the polymer chain P is obtained by polymerization of butadiene units.

The polymer P can thus result from the homopolymerization only of diene units, preferably conjugated diene, preferably butadiene. In these polymers, along the polymer chain, several double bonds can be found resulting from the homopolymerization of the diene units, preferably conjugated diene, preferably butadiene. Such polymers are for example polybutadienes, polyisoprenes, polyisobutenes, polychloroprenes, but also butyl rubbers which are obtained by the concatenation of isobutene and isoprene copolymers. Copolymers or terpolymers obtained from diene units can also be found such as butadiene, isoprene, isobutene, 2,3-dimethyl-1,3-butadiene, 1,3-pentadiene, 1,3-hexadiene, chloroprene units. In addition to these conjugated diene units, other units can be found.

Preferably, the polymer chain P is obtained by copolymerization of conjugated diene units and aromatic monovinyl hydrocarbon units. The aromatic monovinyl hydrocarbons which can be used according to the invention are chosen from styrene, o-methyl styrene, p-methyl styrene, p-tert-butylstyrene, 2,3 dimethyl-styrene, α-methyl styrene, vinyl naphthalene, vinyl toluene and/or vinyl xylene. Preferably, the polymer chain P is obtained by copolymerization of butadiene units and styrene units.

The polymers which can be used as starting material for forming the graft polymers GP according to the invention are therefore, preferably, chosen from the copolymers of aromatic monovinyl hydrocarbon and conjugated diene, in particular of styrene and butadiene, linear or star, in diblock, triblock and/or multibranched form, optionally with or without a random hinge. Preferably the polymer which can be used as starting material for forming the graft polymers GP according to the invention is a diblock or triblock copolymer of aromatic monovinyl hydrocarbon and conjugated diene, in particular a diblock or triblock copolymer of styrene and butadiene. The copolymer of aromatic monovinyl hydrocarbon and conjugated diene, in particular of styrene and butadiene, advantageously has a content by weight of aromatic monovinyl hydrocarbon, in particular of styrene ranging from 5% to 50% by mass, with respect to the mass of copolymer, preferably from 10% to 40%, more preferentially from 15% to 35%, even more preferentially from 20% to 30%. The copolymer of aromatic monovinyl hydrocarbon and conjugated diene, in particular of styrene and butadiene, advantageously has a content by weight of conjugated diene, in particular of butadiene ranging from 50% to 95% by mass, with respect to the mass of copolymer, preferably from 55% to 90%, more preferentially from 60% to 85%, even more preferentially from 65% to 80%.

These conjugated diene units include the units with 1-4 double bonds originating from the conjugated diene and the units with 1-2 double bonds originating from the conjugated diene. By units with 1-4 double bonds originating from the conjugated diene, is meant the units obtained via a 1,4 addition during polymerization of the conjugated diene. By units with 1-2 double bonds originating from the conjugated diene, is meant the units obtained via a 1,2 addition during polymerization of the conjugated diene. The result of this 1,2 addition is a so-called “pendant” vinylic double bond. During the preparation of the graft polymer GP, these are double bonds originating from the conjugated diene, in particular the butadiene units, which are reactive and available for grafting the grafts G. The grafting will take place on the units with 1-4 double bonds originating from the butadiene and the units with 1-2 double bonds originating from the butadiene, in particular on the units with 1-2 double bonds originating from the butadiene, which are a little more reactive.

Preferably, the copolymer of aromatic monovinyl hydrocarbon and conjugated diene, in particular of styrene and butadiene, has a content in units with 1-2 double bonds originating from the conjugated diene, in particular originating from the butadiene, comprised between 5% and 70% by mass, with respect to the total mass of the conjugated diene units, in particular butadiene, preferably between 10% and 60%, more preferentially between 15% and 50%, even more preferentially between 18% and 40%, even more preferentially between 20% and 30%, even more preferentially between 22% and 25%. The copolymer of aromatic monovinyl hydrocarbon and conjugated diene, in particular of styrene and butadiene, has a weight-average molecular weight M_{W} comprised between 10,000 and 500,000 Daltons, preferably between 50,000 and 200,000, more preferentially between 80,000 and 150,000, even more preferentially between 100,000 and 130,000, even more preferentially between 110,000 and 120,000. The copolymer of aromatic monovinyl hydrocarbon and conjugated diene, in particular of styrene and butadiene, has a number-average molecular weight Mₙ comprised between 10,000 and 500,000 Daltons, preferably between 50,000 and 200,000, more preferentially between 80,000 and 150,000, even more preferentially between 100,000 and 130,000, even more preferentially between 110,000 and 120,000. The molecular masses of the copolymer are measured by gel permeation chromatography GPC with polystyrene standards according to standard ASTM D3536. The copolymer of aromatic monovinyl hydrocarbon and conjugated diene, in particular of styrene and butadiene, has a polydispersity index comprised between 1 and 4, preferably between 1.2 and 3, more preferably between 1.5 and 2, and even more preferably between 1.6 and 1.8.

The graft polymers GP according to the invention are prepared in two steps, allowing graft polymers GP with R₁ and R₂ groups comprising a large number of carbon atoms to be easily obtained. In a first step, a thiol derivative of formula (2): HS—R₁—Y with R₁ having the definitions given above and Y a function chosen from the acid, alcohol or amine functions is grafted onto polymer P as defined above, in particular onto a copolymer of an aromatic monovinyl hydrocarbon and a conjugated diene, in particular onto a copolymer of styrene and butadiene.

This thiol derivative will react on the double bonds of polymer P, in particular on the double bonds originating from the conjugated diene units of polymer P, in particular on the double bonds originating from the butadiene units of polymer P. The thiol derivative will react on these double bonds via its thiol function, the other acid, alcohol or amine end being much less reactive.

This acid, alcohol or amine function will then be free on the polymer and available for a second reaction step. This first reaction step is therefore followed by a second reaction step in which the free acid, alcohol or amine functions react with derivatives of general formula (3): Z—R₂ with R₂ having the definitions given above and Z a function chosen from the acid, alcohol, amine, anhydride or isocyanate functions. The reaction between the Y and Z groups leads of course to the formation of the X function of general formula (1).

Thus, the graft polymer GP of general formula (1a) is obtained by the reaction between a thiol derivative of formula (2) HS—R₁—COOH with Y an acid function and a derivative of general formula (3) H₂N—R₂ with Z an amine function, in order to form an X bond which is an amide bond. Of course these are irreversible covalent amide bonds. In order to promote the reaction between the acid Y function and the amine Z function, the acid Y function can be activated beforehand by compounds that are well known in organic chemistry.

Similarly, the graft polymer GP of general formula (1b) is obtained by the reaction between a thiol derivative of formula (2) HS—R₁—NH₂ with Y an amine function and a derivative of general formula (3) HOOC—R₂ with Z an acid function, in order to form a bond which is an irreversible covalent amide bond. In order to promote the reaction between the amine Y function and the acid Z function, the acid function can be activated beforehand by compounds that are well known in organic chemistry Thus, for example, the acid chloride ClCO—R₂ combined with the acid HOOC—R₂ can be reacted.

The graft polymer GP of general formula (1c) is obtained by the reaction between a thiol derivative of formula (2) HS—R₁—NH₂ with Y an amine function and a derivative of general formula (3) with Z a cyclic anhydride function in order to form an X bond which is an amido/acid bond:

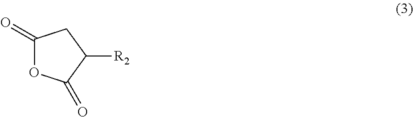

Starting from the graft polymer GP of general formula (1c), the graft polymer of general formula (1f) can be obtained. An internal cyclization reaction takes place under certain temperature conditions, in particular at high temperature. The graft polymer GP of general formula (1d) is obtained by the reaction between a thiol derivative of formula (2) HS—R₁—COOH with Y an acid function and a derivative of general formula (3) HO—R₂ with Z an alcohol function, in order to form an X bond which is an ester bond. The graft polymer GP of general formula (1e) is obtained by the reaction between a thiol derivative of formula (2) HS—R₁—OH with Y an alcohol function and a derivative of general formula (3) HOOC—R₂ with Z an acid function, in order to form an X bond which is an ester bond. In order to promote the formation of the ester bond, the acid chloride ClCO—R₂ combined with the acid HOOC—R₂ could also be reacted.

The graft polymer GP of general formula (1g) is obtained by the reaction between a thiol derivative of formula (2) HS—R₁—NH₂ with Y an amine function and a derivative of general formula (3) OCN—R₂ with Z an isocyanate function, in order to form an X bond which is a urea bond. The graft polymer GP of general formula (1h) is obtained by the reaction between a thiol derivative of formula (2) HS—R₁—OH with Y an alcohol function and a derivative of general formula (3) OCN—R₂ with Z an isocyanate function, in order to form an X bond which is a urethane bond.

The first reaction step involves the polymer P as defined above and the thiol derivative of formula (2) as defined above. The polymer P and the thiol derivative of formula (2) are reacted at a temperature comprised between 20 and 200° C., preferably between 40 and 180° C., more preferentially between 60 and 140° C., even more preferentially between 80 and 120° C. The polymer P and the thiol derivative of formula (2) are reacted for a duration of from 10 minutes to 48 hours, preferably from 30 minutes to 24 hours, more preferentially from 1 hour to 10 hours, even more preferentially from 2 hours to 4 hours. The mass ratio between the quantities of thiol derivative of formula (2) and of polymer P is comprised between 0.01 and 5, preferably between 0.05 and 4, more preferentially between 0.1 and 2, even more preferentially between 0.5 and 1.5, even more preferentially between 0.8 and 1. The molar ratio between the quantities of thiol derivative of formula (2) and of units originating from the conjugated diene of polymer P, preferably of 1-2 units originating from the conjugated diene of polymer P, is comprised between 0.01 and 5, preferably between 0.05 and 4, more preferentially between 0.1 and 2, even more preferentially between 0.5 and 1.5, even more preferentially between 0.8 and 1.

The reaction between the polymer P and the thiol derivative of formula (2) preferably takes place in a solvent such as toluene, but the mixing of these two reagents can also be carried out without organic solvent, the mixing of the two reagents taking place in polymer P heated to the temperatures mentioned above. In order to promote the reaction between polymer P and the thiol derivative of formula (2), a radical initiator can optionally be added. This radical initiator is preferably azobisisobutyronitrile (AIBN). By optimizing the temperature and duration conditions, the radical initiator can be omitted.

An inert atmosphere can also optionally be used for this first reaction step, such as an inert atmosphere of nitrogen or argon. The first reaction step can be carried out with or without mechanical stirring. The grafting of the thiol derivative of formula (2) can be improved by using any type of mechanical stirring.

The product of the reaction between polymer P and the thiol derivative of formula (2) can optionally be purified by precipitation from a solvent such as methanol. An anti-oxidant agent, such as 2,6-di-tert-butyl-4-methylphenol can optionally be added to the product of the reaction between polymer P and the thiol derivative of formula (2). This anti-oxidant agent can be added with solvent such as toluene, which solvent is then evaporated off.

During this first grafting reaction step, chain cleavage and/or chain branching can occur at the level of the polymer chain. This can result in irreversible covalent-type coupling, branching, partial cross-linking of the polymer chains, which would add to the reversible thermal cross-linking due to the R₁, R₂ and/or X groups. This phenomenon is of minor importance, as the reversible thermal cross-linking is predominant.

The second reaction step involves the product of the reaction between polymer P and the derivative of formula (2), i.e. the reaction product of the first step, and a derivative of formula (3) as defined above. The product of the reaction of the first step and the derivative of formula (3) are reacted at a temperature comprised between 0 and 200° C., preferably between 10 and 180° C., more preferentially between 20 and 140° C., even more preferentially between 40 and 120° C., even more preferentially between 80 and 100° C. The product of the reaction of the first step and the derivative of formula (3) are reacted for a duration of from 10 minutes to 48 hours, preferably from 30 minutes to 24 hours, more preferentially from 1 hour to 10 hours, even more preferentially from 2 hours to 4 hours. The reaction between the product of the reaction of the first step and the derivative of formula (3) preferably takes place in a solvent such as toluene.

In order to synthesize the graft polymer GP of general formula (1a), to activate the acid functions present on the reaction product of the first step, an activator is preferably added such as a mixture of N-hydroxysuccinimide and dicyclohexylcarbodiimide, any other standard activator used in peptide chemistry can be used. It is only after this activation, that the derivative of formula (3) is added in order to form the amide bond. An inert atmosphere can also optionally be used for this second reaction step, such as an inert atmosphere of nitrogen, or of argon.

The second reaction step can be carried out with or without mechanical stirring. The grafting of the derivative of formula (3) can be improved by using any type of mechanical stirring. The product of the second reaction step can optionally be purified by precipitation from a solvent such as methanol.

An anti-oxidant agent, such as 2,6-di-tert-butyl-4-methylphenol can optionally be added to the product of the second reaction step. This anti-oxidant agent can be added with solvent such as toluene, which solvent is then evaporated off.

The graft polymers GP according to the invention are of use in many fields, and in particular in additives for controlling and improving the viscosity and fluidity of formulations, additives for modifying the gel-like appearance of organic solutions, rheological and/or adhesion additives for coatings on different types of surface, additives to vary the fluidity of paints, additives in the formulation of non-modified bitumens and modified bitumens, additives in the formulation of cements or construction materials, additives in the formulation of rubber, anticorrosion additives, additives in the fields of textile, fabric and paper, additives for impact modification in polymers, additives for glues, adhesive formulations, additives for lubricants, additives in cosmetic formulations, additives in inks, additives in photographic materials, additives for materials for printed circuits. Therefore a subject of the invention is also bitumen/polymer compositions comprising the graft polymers GP according to the invention. The bitumen/polymer compositions comprise from 0.1 to 40% by mass of graft polymers GP, with respect to the mass of the bitumen/polymer compositions, preferably from 0.5 to 30%, more preferentially from 1 to 20%, even more preferentially from 2 to 10%, even more preferentially from 3 to 5%.

The bitumen which can be used according to the invention can be a bitumen of different origins. The bitumen which can be used according to the invention can be chosen from the bitumens of natural origin, such as those contained in deposits of natural bitumen, natural asphalt or bituminous sands. The bitumen which can be used according to the invention can also be a bitumen or a mixture of bitumens resulting from the refining of crude oil such as bitumens resulting from direct or reduced pressure distillation or also blown or semi-blown bitumens, propane or pentane de-asphalting residues, visbreaking residues, these different cuts being alone or in a mixture. The bitumens used can also be bitumens fluxed by the addition of volatile solvents, fluxes originating from oil, carbochemical fluxes and/or fluxes of vegetable origin. It is also possible to use synthetic bitumens also called clear, pigmentable or colourable bitumens. The bitumen can be a bitumen of naphthenic or paraffinic origin, or a mixture of these two bitumens. The bitumens of paraffinic origin are preferred.

The other polymers optionally present in the bitumen/polymer compositions are polymers which can be used in a standard fashion in the field of bitumen/polymer compositions, such as for example the triblock copolymers of an aromatic monovinyl hydrocarbon block and a conjugated diene block such as the styrene/butadiene/styrene SBS triblock copolymers, the multibranched copolymers of aromatic monovinyl hydrocarbon blocks and a conjugated diene block, such as the styrene/butadiene (SB)ₙX multibranched block copolymers, copolymers of an aromatic monovinyl hydrocarbon block and a “random” conjugated diene block such as the styrene/butadiene rubber SBR copolymers, polybutadienes, polyisoprenes, powdered rubbers originating from tyre recycling, butyl rubbers, polyacrylates, polymethacrylates, polychloroprenes, polynorbornenes, polybutenes, polyisobutenes, polyolefins such as polyethylenes, polypropylenes, copolymers of ethylene and vinyl acetate, copolymers of ethylene and methyl acrylate, copolymers of ethylene and butyl acrylate, copolymers of ethylene and maleic anhydride, copolymers of ethylene and glycidyl methacrylate, copolymers of ethylene and glycidyl acrylate, copolymers of ethylene and propylene, ethylene/propylene/diene (EPDM) terpolymers, acrylonitrile/butadiene/styrene (ABS) terpolymers, ethylene/alkyl acrylate or methacrylate/glycidyl acrylate or methacrylate terpolymers and in particular ethylene/methyl acrylate/glycidyl methacrylate terpolymers and ethylene/alkyl acrylate or alkyl methacrylate/maleic anhydride terpolymers and in particular ethylene/butyl acrylate/maleic anhydride terpolymers.

In addition to the bitumen and graft polymers, other optional ingredients commonly used in bitumens can be present. These ingredients can be fluxes such oils based on animal and/or vegetable fatty materials or on hydrocarbon oils of petroleum origin. The oils of animal and/or vegetable origin can be in the form of free fatty acids, triglycerides, diglycerides, monoglycerides, in esterified form, for example in the form of methyl ester.

These ingredients can be waxes of animal, vegetable or hydrocarbon origin, in particular long-chain hydrocarbon waxes, for example polyethylene waxes or Fischer-Tropsch waxes. The polyethylene waxes or Fischer-Tropsch waxes can optionally be oxidized. The fatty amide waxes such as ethylene bis-stearamide can also be added.

These ingredients can be resins of vegetable origin such as colophanes. These ingredients can be acids such as polyphosphoric acid or diacids, in particular fatty diacids. These ingredients can be adhesiveness dopes and/or surfactants. They are chosen from the derivatives of alkylamines, derivatives of alkyl-polyamines, derivatives of alkylamidopolyamines, derivatives of alkyl amidopolyamines and derivatives of quaternary ammonium salts, alone or in a mixture. The most used are tallow propylene-diamines, tallow amido-amines, quaternary ammoniums obtained by quaternization of tallow propylene-diamines, tallow propylene-polyamines.

The bitumen/polymer compositions are prepared by mixing the graft polymer GP and bitumen. Mixing takes place at a temperature comprised between 80° C. and 200° C., preferably between 100° C. and 180° C., more preferentially between 120° C. and 160° C., for a duration of 30 minutes to 4 hours, preferably from 1 hour to 2 hours, optionally under stirring. The graft polymers GP obtained according to the method described above can be used in the field of bitumens, in road making and/or in industry. The graft polymers GP make it possible to formulate bituminous compositions and in particular bitumen/polymer compositions that are cross-linked, preferably thermoreversibly.

The cross-linking of the bitumen/polymer compositions comprising said graft polymers can be demonstrated by subjecting these bitumen/polymer compositions to tensile testing according to standard NF EN 13587. The cross-linked bitumen/polymer compositions have higher tensile strength than the non-cross-linked bitumen/polymer compositions. A higher tensile strength is reflected in a high elongation at break or maximum elongation (ε max in %), a high breaking stress or stress at maximum elongation (σε max in MPa), a high conventional energy at 400% (E 400% in J/cm²) and/or a high total energy (E total in J).

The cross-linked bitumen/polymer compositions have a maximum elongation, according to standard NF EN 13587, greater than or equal to 400%, preferably greater than or equal to 500%, more preferentially greater than or equal to 600%, and even more preferentially greater than or equal to 700%. The cross-linked bitumen/polymer compositions have a stress at maximum elongation, according to standard NF EN 13587, greater than or equal to 0.2 MPa, preferably greater than or equal to 0.4 MPa, more preferentially greater than or equal to 0.6 MPa, and even more preferentially greater than or equal to 1 MPa. The cross-linked bitumen/polymer compositions have a conventional energy at 400%, according to standard NF EN 13587, greater than or equal to 3 J/cm², preferably greater than or equal to 5 J/cm², more preferentially greater than or equal to 10 J/cm², and even more preferentially greater than or equal to 15 J/cm². The cross-linked bitumen/polymer compositions have a total energy, according to standard NF EN 13587, greater than or equal to 1 J, preferably greater than or equal to 2 J, more preferentially greater than or equal to 4 J, and even more preferentially greater than or equal to 5 J.

The bitumen/polymer compositions comprising the graft polymers can be intended for the manufacture of mixes, surface coatings (road making applications) or membranes, sealing coats (industrial applications). The bituminous mix comprises from 1 to 10% by mass of bitumen/polymer composition, with respect to the total weight of the mix, preferably from 4 to 8 by mass. The use of graft polymers GP in bitumen/polymer compositions, during manufacture of a mix, makes it possible to reduce the manufacturing or coating, spreading and compacting temperatures with respect to the temperatures normally used. In fact due to thermoreversible cross-linking, the bitumen/polymer compositions have both reduced viscosities in the ranges of manufacturing temperatures of a mix (implementation temperatures) due to the disappearance of the crystalline domains due to the R₁ and R₂ groups and interactions that are polar or via hydrogen bonds due to the X function of the polymer GP and at the same time the return of these crystalline domains and these interactions when the temperatures decrease and, as a result, good mechanical properties at the temperatures of use (consistency, elasticity for example).

### EXAMPLES

### Example 1

### Preparation of a polymer P—S—C₁₄H₂₈—CONH—C₁₈H₃₇—6.5% molar

The graft polymer GP of type P—S—R₁—X—R₂ according to the invention is prepared, having the general formula P—S—C₁₄H₂₈—CONH—C₁₈H₃₇, with P the polymer chain, R₁ representing the C₁₄H₂₈ group, R₂ representing the C₁₈H₃₇ group and X representing an amide function. This graft polymer is prepared from:
styrene/butadiene/styrene SBS triblock copolymer having a mass M_{w} equal to 122,000 g.mol⁻¹, a mass Mₙ equal to 115,000 g.mol⁻¹, a polydispersity index equal to 1.06, a quantity by mass of styrene of 30.4%, a quantity by mass of 1,2-butadiene of 26.6%, a quantity by mass of 1,4-butadiene of 43%, with respect to the mass of the copolymer.
thiol derivative/acid of formula (2): HS—C₁₄H₂₈—COOH,
amine derivative of formula (3): H₂N—C₁₈H₃₇.

Preparation of the Graft Polymer GP According to the Invention

The graft polymer GP is synthesized in two steps. The first step corresponds to a radical addition of an alkanethiol comprising a carboxylic acid function (mercaptoalkanoic acid). The second step corresponds to the amidification of the acid functions with an amine derivative.

First Step

110 ml of toluene and 4 g of SBS polymer described above are introduced into a reaction vessel maintained under nitrogen atmosphere and at ambient temperature. Then 2.6 g of thiol derivative/acid described above is introduced into the reaction vessel. The mixture is brought to 90° C. and 15 mg of AIBN (azobisisobutyronitrile) solubilized in 1 ml of degassed toluene is added. After 3 hours and 30 minutes at 90° C., under an inert atmosphere, the solution is cooled down to ambient temperature. The polymer is precipitated three times from methanol. The polymer is then solubilized in toluene and 2,6-di-tert-butyl-4-methylphenol is added (1 mg per 1 g of polymer). The solution is poured into a Teflon mould and the toluene is evaporated off. The polymer films are dried under vacuum for 24 hours and stored at 4° C.

The molar % of grafted thiol derivative/acid, with respect to the butadiene units is 12%. This molar % of grafted thiol derivative/acid is the number of moles of grafted thiol derivative/acid with respect to the number of moles of the butadiene units present on the starting polymer chain. The molar % of grafted thiol derivative/acid, with respect to the butadiene units and to the styrene units is 10%. This molar % of grafted thiol derivative/acid is the number of moles of grafted thiol derivative/acid with respect to the number of moles of the butadiene units and of the styrene units present in the starting polymer chain.

The % by mass of grafted thiol derivative/acid is 32%. This % by mass of grafted thiol derivative/acid is the mass of grafted thiol derivative/acid with respect to the total mass of graft polymer obtained in the first reaction step. The grafting yield of the first reaction step is 65%. By grafting yield is meant the quantity of grafted thiol derivative/acid with respect to the quantity of thiol derivative/acid introduced in this first step.

Second Step

3 g of the polymer obtained during the first reaction step is solubilized in 90 ml of toluene at ambient temperature and under stirring. Then 0.8 g of N-hydroxysuccinimide is introduced. 0.46 g of dicyclohexylcarbodiimide is solubilized in 1 ml of toluene, which is then added dropwise to the reaction medium. The mixture is stirred at ambient temperature for 5 hours. Then 1.06 g of the amine derivative described above, previously solubilized in 1 ml of toluene, is introduced and left to react for 10 hours. The mixture is precipitated twice from methanol. The graft polymer GP obtained is then solubilized in toluene and 2,6-di-tert-butyl-4-methylphenol (1 mg per 1 g of polymer) is added. The solution is poured into a Teflon mould and the toluene is evaporated off. The polymer films are dried under vacuum for 24 hours and stored at 4° C.

The molar % of grafted thiol derivative/amide is 8.1% with respect to the butadiene units. This molar % of grafted thiol derivative/amide is the number of moles of grafted thiol derivative/amide with respect to the number of moles of the butadiene units present on the starting polymer chain. The molar % of grafted thiol derivative/amide, with respect to the butadiene units and the styrene units is 6.5%. This molar % of grafted thiol derivative/amide is the quantity of grafted thiol derivative/amide with respect to the number of moles of the butadiene units and of the styrene units present in the starting polymer chain.

The % by mass of grafted thiol derivative/amide is 32%. This % by mass of grafted thiol derivative/amide is the mass of grafted thiol derivative/amide with respect to the total mass of graft polymer obtained in the second reaction step. The grafting yield of the second reaction step is 65%. By grafting yield is meant the quantity of grafted amine derivative with respect to the quantity of amine derivative introduced in this second step.

Properties of the Graft Polymer GP

The viscoelastic properties of the graft polymer GP, and in particular the formation of a gel in a 10% by mass solution in toluene, were investigated by measuring the moduli G′ (storage modulus) and G″ (loss modulus) under cooling and heating (between 25° C. and −8° C. at 0.5° C./min under a frequency of 0.9 rad.s⁻¹ and a deformation of 1%).

The results are shown in Table I below.

TABLE I

| Temperature | G′ (Pa) | G″ (Pa) | G′ (Pa) | G″ (Pa) |
|---|---|---|---|---|
| (° C.) | Cooling | Cooling | Heating | Heating |
| −8 | 54000 | 1240 | 54000 | 1240 |
| −6 | 41500 | 990 | 52900 | 1180 |
| −4 | 35400 | 830 | 50100 | 1100 |
| −2 | 28600 | 660 | 48400 | 1020 |
| 0 | 21500 | 470 | 42800 | 840 |
| 2 | 14000 | 300 | 41100 | 810 |
| 4 | 6640 | 160 | 33600 | 630 |
| 7 | 590 | 20 | 26700 | 470 |
| 10 | 4 | 1 | 19000 | 310 |
| 11 | 0.3 | 0.4 | 18700 | 290 |
| 13 | — | — | 11100 | 170 |
| 16 | — | — | 4290 | 60 |
| 19 | — | — | 634 | 11 |
| 22 | — | — | 1.5 | 0.5 |
| 25 | — | — | — | — |

At ambient temperature (20-25° C.), the solution of polymer GP is very liquid. During cooling, starting from 10° C., the values of the moduli G′ and G″ increase very significantly with the values of modulus G′ much greater than those of modulus G″, which demonstrates the formation of a gel with a high elastic component. The graft polymer GP is therefore capable of forming a gel in solution. The gelling takes place around 10° C. during cooling. This gel disappears when heating is applied around 22° C., which demonstrates the thermoreversibility of the system.

The viscosities of the graft polymer GP (10% by mass in toluene) are also measured. Flow measurements cannot be carried out as a function of temperature because the gel formed by the graft polymer GP is so strong that there is a risk of fracturing it when putting it under stress in this way. For this reason, only oscillation measurements (measurements of moduli G′ and G″) are carried out as a function of temperature. These measurements give access to a complex viscosity η* (η*=G*/ω with G* the complex modulus).

The results are shown in Table II below.

TABLE II

| Temperature (° C.) | Viscosity (Pa · s) |
|---|---|
| 25 | 0.098 |
| 20 | 0.415 |
| 15 | 0.752 |
| 10 | 501 |
| 5 | 1290 |
| 0 | 2200 |
| −5 | 3140 |
| −8 | 3950 |
| −10 | — |

A sudden increase in the viscosity is noted starting from 10° C. These viscosity measurements are well correlated with the measurements of moduli G′ and G″ which demonstrate that the graft polymer GP is capable of forming a thermoreversible gel in toluene around 10° C.

### Example 2

### Preparation of a polymer P—S—C₁₄H₂₈—CONH—C₁₈H₃₇—1.5% molar

A graft polymer GP of type P—S—C₁₄H₂₈—CONH—C₁₈H₃₇ according to the invention is synthesized according to an operating procedure identical to Example 1, with the exception of the quantities of the thiol derivative/acid of formula (2) and of the amine derivative of formula (3) as well as the quantities of AIBN, N-hydroxysuccinimide and dicyclohexylcarbodiimide adjusted so as to obtain a molar % of the grafted thiol derivative/amide with respect to the butadiene units and to the styrene units of 1.5%.

First Step

0.64 g of the thiol derivative/acid of formula (2) and 3.85 mg of AIBN are used, the quantities of the other components remaining identical to Example 1. Then a molar % of grafted thiol derivative/acid is obtained, which with respect to the butadiene units is 2% and a molar % of grafted thiol derivative/acid, which with respect to the butadiene units and to the styrene units is 1.5%. The % by mass of grafted thiol derivative/acid is 6% and the grafting yield of the first reaction step is 40%.

Second Step

83 mg of N-hydroxysuccinimide, 0.15 g of dicyclohexylcarbodiimide and 0.19 g of amine derivative of formula (3) are used, the quantities of the other components remaining identical to Example 1. The molar % of grafted thiol derivative/amide, with respect to the butadiene units is 2% and the molar % of grafted thiol derivative/amide, with respect to the butadiene units and to the styrene units is 1.5%. The % by mass of grafted thiol derivative/amide is 11%. The grafting yield of the second reaction step is 100%.

### Example 3

### Preparation of a Bitumen/Polymer Composition

Bitumen

The bitumen is a bitumen of penetrability 50 1/10 mm, the characteristics of which correspond to the standard NF EN 1426.

Bitumen/Polymer Composition C According to the Invention

A bitumen/polymer composition is prepared from the bitumen described above and the graft polymer GP of formula P—S—C₁₄H₂₈—CONH—C₁₈H₃₇ of Example 2 at a concentration of 5% by mass. The bitumen described above is introduced into a reaction vessel maintained at 180° C. and equipped with a mechanical stirring system. The bitumen is heated at 180° C. and stirred for approximately 60 minutes. Then the graft polymer GP of formula P—S—C₁₄H₂₈—CONH—C₁₈H₃₇ is added at 5% by mass. Mixing is carried out for a duration of 4 hours under stirring.

Control Bitumen/Polymer Composition T₁

A non-cross-linked control bitumen/polymer composition is prepared as follows: The bitumen described above is placed in a reaction vessel. The bitumen is heated at 180° C. and stirred for approximately 60 minutes. Then 5% by mass of the styrene/butadiene/styrene SBS triblock copolymer described in Example 1 is added. The mixture is stirred and heated at 180° C. for approximately 4 hours.

Control Bitumen/Polymer Composition T₂

An irreversibly cross-linked control bitumen/polymer composition is also prepared as follows: A control bitumen/polymer composition T₁ is prepared as described above, to which 0.13% by mass of sulphur is added. The mixture thus obtained is stirred and heated at 180° C. for 1 h30.

The following table shows the physical characteristics of compositions C, T₁ and T₂.

Results

| | C | T₁ | T₂ |
|---|---|---|---|
| Penetrability (0.1 mm) (1) | 36 | 52 | 36 |
| RBT (° C.) (2) | 62.6 | 56.2 | 64.2 |
| Viscosity at 80° C. | 80.85 | 37.00 | 65.00 |
| Viscosity at 100° C. | 12.26 | 14.36 | 17.49 |
| Viscosity at 120° C. | 4.01 | 3.91 | 4.80 |
| Viscosity at 140° C. | 1.19 | 1.30 | 1.61 |
| Viscosity at 160° C. | 0.46 | 0.55 | 0.69 |
| Viscosity at 180° C. | 0.23 | 0.28 | 0.34 |
| Viscosity at 200° C. | 0.14 | 0.17 | 0.20 |
| Max. elongation at 5° C. (%) (3) | 700 | 95 | 700 |
| Stress (daN/cm²) (3) | 16.34 | / | 12.01 |

(1) According to standard EN 1426
(2) Ring and Ball Temperature, according to standard EN1427
(3) Tensile test at 5° C., according to standard NF T 66-038, with a stretching rate of 100 mm/min.

The results of this table demonstrate that the bitumen/olymer composition according to the invention is less viscous starting from 100° C. than the non-cross-linked bitumen/polymer composition T₁ and composition T₂ cross-linked with sulphur. Moreover, it is noted that at the temperatures of use, the elastic and elongation properties of the bitumen/polymer composition according to the invention are improved with respect to a non-cross-linked bitumen/polymer composition T₁ and comparable to those of the bitumen/polymer composition T₂ cross-linked with sulphur. A thermoreversible effect is therefore observed.

1. A graft polymer GP comprising a main polymer chain P and at least one side graft G connected to the main polymer chain P, the graft G having general formula (1):
—S—R₁—X—R₂ (1)
with R₁ and R₂ which represent independently of one another, linear or branched, unsaturated or saturated hydrocarbon groups such that the total number of carbon atoms of the R₁ and R₂ groups is comprised between 2 and 110, X which represents an amide, amido-acid, urea or urethane function, and the graft G being connected to the main polymer chain P via the sulphur atom.

2. The graft polymer according to claim 1, in which the total number of carbon atoms of the R₁ and R₂ groups is comprised between 4 and 90.

3. The graft polymer according to claim 1, in which R₁ represents a linear, saturated hydrocarbon group, of formula CₙH₂ₙ and R₂ represents a linear, saturated hydrocarbon group of formula CₘH₂ₘ₊₁ with n and m being integers such that the sum n +m is comprised between 2 and 110.

4. The graft polymer according to claim 3, in which n is comprised between 1 and 60 and m is comprised between 1 and 50.

5. The graft polymer according to claim 1, in which the main polymer chain P results from the copolymerization of conjugated diene units and monovinyl aromatic hydrocarbon units.

6. The graft polymer according to claim 5, comprising a content of units with 1-2 double bonds originating from the conjugated diene, comprised between 5% and 70% by mass, with respect to the total mass of the conjugated diene units.

7. The graft polymer according to claim 1, in which X represents an amide function and the general formula (1) is as follows:

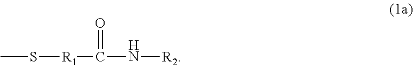

8. A process for the preparation of a graft polymer comprising:
connecting at least one side graft G to a main polymer chain P, the graft G having general formula (1):
—S—R₁—X—R₂ (1)
with R₁ and R₂ which represent independently of one another, linear or branched, unsaturated or saturated hydrocarbon groups such that the total number of carbon atoms of the R₁ and R₂ groups is comprised between 2 and 110, X which reprresents an amide, amido-acid, urea or urethane function, and the graft G being connected to the main polymer chain P via the sulphur atom; and
reacting, in a first step, at least one polymer P and at least one thiol derivative of general formula (2): HS—R₁—Y, then in a second step at least one derivative of general formula (3): Z—R₂, with R₁ and R₂ which represent independently of one another, linear or branched, unsaturated or saturated hydrocarbon groups such that the total number of carbon atoms of the R₁ and R₂ groups is comprised between 2 and 110, Y which represents an acid, alcohol or amine function, Z which represents an acid, alcohol, amine, anhydride or isocyanate function, it being understood that the reaction between the two functions Y and Z leads to the X function of general formula (1).

9. A method for manufacturing in at least one of: coatings, paints, thermoplastics, glues, lubricants, fuels, inks, cements, construction materials, rubbers or bitumens comprising using the graft polymer as claimed in claim 1.

10. A bitumen/polymer composition comprising at least one bitumen and at least one graft polymer according to claim 1.

11. The bitumen/polymer composition according to claim 10, comprising from 0.1 to 40% by mass of the graft polymer, with respect to the mass of the bitumen/polymer composition.

12. The process according to claim 8, further comprising mixing at least one bitumen and at least one of the graft polymer at a temperature comprised between 80° C. and 200° C., for a duration of 30 minutes to 4 hours.

13. A method for thermoreversible cross-linking of a bitumen/polymer composition comprising introducing a graft polymer in the bitumen/polymer composition, and the graft polymer comprises a main polymer chain and at least one side graft connected to the main polymer chain, the graft having general formula (1):
—S—R₁—X—R₂ (1)
with R₁ and R₂ which represent independently of one another, linear or branched, unsaturated or saturated hydrocarbon groups such that the total number of carbon atoms of the R₁ and R₁ groups is comprised between 2 and 110, X which represents an amide, amido-acid, urea or urethane function, and the graft being connected to the main polymer chain via the sulphur atom.

14-15. (canceled)

16. The graft polymer according to claim 5, in which the main polymer chain P results from the copolymerization of butadiene units and styrene units.

17. The graft polymer according to claim 6, further comprising a content of units with 1-2 double bonds originating from butadiene comprised between 5% and 70% by mass, with respect to the total mass of the butadiene units. 0
